(19) United States
(12) Patent Application Publication
(10) Pub. No.: US 2016/0349867 A1
(43) Pub. Date: Dec. 1, 2016

(54) TOUCH PANEL AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Wenjin Fan, Beijing (CN); Taofeng Xie, Beijing (CN); Ming Hu, Beijing (CN)

(21) Appl. No.: 14/892,006

(22) PCT Filed: May 28, 2015
(86) PCT No.: PCT/CN2015/080091

§ 371 Date: Nov. 18, 2015

(30) Foreign Application Priority Data
Dec. 16, 2014 (CN) 201410782369.2

(51) Int. Cl. G06F 3/041

(52) U.S. Cl. CPC G06F 3/041

(57) ABSTRACT

Embodiments of the invention provide a touch panel and a display device, which relates to the technical field of display and solves the problem that the connecting electrodes of an existing touch panel are easily eroded by water, oxygen, etc. in the air. A touch panel comprises a circuit binding area formed with a plurality of connecting electrodes for binding and electrically connecting with a circuit board. The touch panel further comprises a protective layer at least covering one side surface of the connecting electrode.

The present application is the U.S. national phase entry of PCT/CN2015/080091, filed May 28, 2015, which claims the benefit of Chinese Patent Application No. 201410782369.2, filed Dec. 16, 2014, the entire disclosures of which are incorporated herein by reference.

### FIELD OF THE INVENTION

The present invention relates to the technical field of display, in particular to a touch panel and a display device.

### BACKGROUND OF THE INVENTION

Touch screen is also called “touch screen”, which provides a simplest, most convenient and natural human-machine interaction manner at present. It imparts a new look to multimedia, which is an extremely attractive, bran-new multimedia interaction device.

Specifically, as shown in FIG. 1, a touch panel generally comprises a touch function area 21 and a circuit binding area 22. The touch function area 21 is generally provided with a plurality of interlaced touch sensing electrodes Rx and touch driving electrodes Tx. The touch sensing electrodes Rx and the touch driving electrodes Tx are electrically connected with connecting electrodes 20 of the circuit binding area 22 respectively in the circuit binding area 22. The connecting electrodes 20 are bound and connected with a FPC (flexible printed circuit) board 30, etc. When a finger touches the display screen, the touch sensing electrodes Rx and the touch driving electrodes Tx transmit a touch signal to the FPC board via the connecting electrodes to process the touch signal, enabling the touch function.

As shown in FIG. 2, the flexible printed circuit board 30 is provided with a plurality of connecting lines 31 for binding and connecting the flexible printed circuit board 30 with the connecting electrodes 20 of the circuit binding area 22, mainly enabling contact and electrical connection between the connecting lines 31 of the flexible printed circuit board and the connecting electrodes 20. However, in order to achieve a good contact effect between the connecting lines 31 of the flexible printed circuit board and the connecting electrodes 20, and between the connecting lines 31 and the flexible printed circuit board 30, the connecting electrodes 20 at the circuit binding area 22 of the touch panel are generally exposed to air, such that the connecting electrodes 20 in the circuit binding area 22 are easily eroded by water, oxygen, etc. in the air, which may even lead to failure of the touch function.

### SUMMARY OF THE INVENTION

The embodiments of the present invention provide a touch panel and a display device. Connecting electrodes of the touch panel not only can achieve good electrical contact with a circuit board, but also can be prevented from erosion by water, oxygen, etc. in the air.

The embodiments of the present invention employ the following technical solutions.

In one aspect, an embodiment of the present invention provides a touch panel comprising a circuit binding area, the circuit binding area is formed with a plurality of connecting electrodes for binding and electrically connecting with a circuit board; the touch panel further comprises a protective layer at least covering one side surface of the connecting electrode.

In another aspect, embodiments of the present invention provide a display device comprising a touch panel as provided by any embodiment among the respective embodiments of the present invention.

The embodiments of the present invention provide a touch panel and a display device. In the embodiments of the invention, the protective layer of the circuit binding area of the touch panel may cover side surfaces of a plurality of connecting electrodes, which can protect the connecting electrodes from erosion by water, oxygen, etc. in the air, guaranteeing the performance of the connecting electrodes, and extend service life of the connecting electrodes.

### BRIEF DESCRIPTION OF THE DRAWINGS

In order to set forth the technical solutions of the embodiments of the present invention or the prior art more clearly, next, figures needed to be used for describing the embodiments or the prior art will be introduced simply. Obviously, the figures described below are just some embodiments of the invention. Those ordinarily skilled in the art may obtain other figures based on these figures without spending inventive efforts.

FIG. 1 is a schematic diagram of a planar structure of an existing touch panel.

FIG. 2 is a schematic diagram of a cross section of an existing circuit binding area.

FIG. 3 is a schematic diagram of a cross section of a circuit binding area according to an embodiment of the present invention.

FIG. 4 is a schematic diagram of a cross section of circuit binding area according to another embodiment of the present invention.

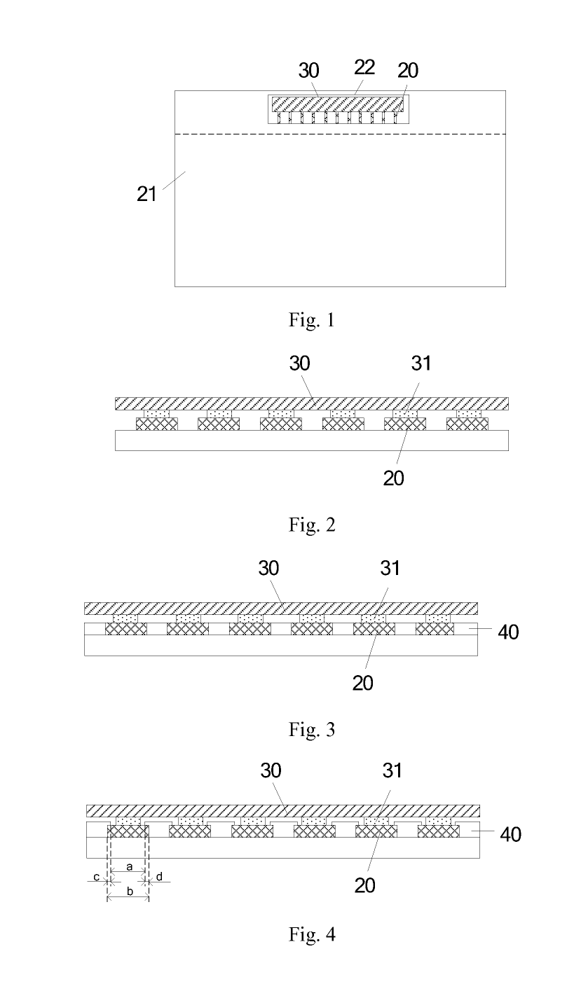

### REFERENCE SIGNS

20—connecting electrode; 21—touch function area; 22—circuit binding area; 30—flexible printed circuit board; 31—connecting line; 40—protective layer.

### DETAILED DESCRIPTION OF THE INVENTION

The technical solutions of the embodiments of the present invention will be clearly and comprehensively described as follows in combination with the figures of the embodiments of the present invention. Obviously, the described embodiments are only a part of the embodiments of the present invention, rather than all of them. All the other embodiments obtained by those ordinarily skilled in the art based on these embodiments without spending any inventive efforts pertain to the protection scope of the present invention.

An embodiment of the invention provides a touch panel comprising a circuit binding area, and the circuit binding area is formed with a plurality of connecting electrodes for binding and electrically connecting with a circuit board. The touch panel further comprises a protective layer at least covering one side surface of the connecting electrode.

In the embodiment of the invention, the connecting electrodes of the circuit binding area are electrically connected with a flexible printed circuit board, so as to transmit a touch signal to the flexible printed circuit board via the connecting electrodes. The touch panel may comprise one circuit binding area, or a plurality of circuit binding areas can be provided for a touch panel with a large size. The embodiments of the invention make detailed explanation just taking the situation that the touch panel comprises one circuit binding area as an example.

The protective layer may be formed by means of a patterning process. The so-called “patterning process” refers to a process for forming a thin film into a layer comprising at least one pattern. The patterning process may comprise: coating a photoresist on the thin film; exposing the photoresist using a mask; then eroding the photoresist needed to be removed using a developing solution; then etching the thin film portion not covered by the photoresist; finally stripping the remaining photoresist. To form the protective layer, the mask applied to the embodiments of the invention may comprise a light-transmitting pattern and an opaque pattern in an area corresponding to the circuit binding area of the touch panel.

The connecting electrode may be formed from any conductor material. In the embodiments of the present invention, a metal connecting electrode is employed as the connecting electrode, which has stable conductivity and a small resistance.

In one embodiment of the invention, an upper surface of the connecting electrode is in contact with the connecting line of the flexible printed circuit board. The protective layer in the circuit binding area of the touch panel may cover one side surface of a plurality of connecting electrodes, hence the protective layer may protect the connecting electrodes from erosion by water, oxygen, etc. in the air, guaranteeing the performance of the connecting electrodes and extend service life of the connecting electrodes.

In an embodiment of the invention as shown in FIG. 3, a protective layer 40 covers two side surfaces of a connecting electrode 20, thereby protecting, at the two side surfaces, the connecting electrode from erosion by water, oxygen, etc. in the air.

In an embodiment of the invention, the protective layer may cover one side surface or two side surfaces of each connecting electrode among a plurality of connecting electrodes, thereby protecting each connecting electrode from erosion by water, oxygen, etc. in the air.

In another embodiment of the invention, the protective layer may further cover a portion of the upper surface of the connecting electrode, and the width of the portion of the upper surface of the connecting electrode which is covered by the protective layer is not greater than 30% of the width of the connecting electrode. In this embodiment, the width of the connecting electrode may be greater than the width of the electrically conductive line (i.e. connecting line) of the flexible printed circuit board. The protective layer may further cover a portion of the upper surface of the connecting electrode, so as to prevent the portion of the connecting electrode which does not contact the electrically conductive line of the flexible printed circuit board from contacting with air. Moreover, in order to ensure that the connecting electrode has a sufficient surface for contacting with the electrically conductive line of the flexible printed circuit board, the width of the portion of the connecting electrode which is covered by the protective layer may be not larger than 30% of the width of the connecting electrode. For example, the width of the portion of the connecting electrode which is covered by the protective layer may be 10%, 15% or 20% of the width of the connecting electrode.

The following detailed explanation is made by taking the protective layer covering 10% of the width of the connecting electrode as an example. The protective layer covers 10% of the width of the connecting electrode, which may only cover one side of the upper surface of the connecting electrode. The connecting lines of the flexible printed circuit board may be formed in row and correspond to respective connecting electrodes. Further, in order to make each connecting electrode in contact and electrically connected with a corresponding connecting line of the flexible printed circuit board, in another embodiment according to the present invention as shown in FIG. 4, portions of the upper surface of the connecting electrode 20 which are covered by the protective layer 40 are located at two sides of the portion not covered by the protective layer. Namely, the two sides of the upper surface of the connecting electrode 20 are covered by the protective layer 40, whereas the middle portion thereof is exposed such that it can be connected with the connecting line 31 of the flexible printed circuit board. Further, the width of each of the portions of the upper surface of the connecting electrode 20 which are covered by the protective layer 40 and located at two sides of the portion not covered by the protective layer is not greater than 5% of the width of the connecting electrode. Namely, the width of the portions covered by the protective layer is not greater than 10% of the width of the connecting electrode. Specifically, as shown in FIG. 4, supposing that the width of a single connecting electrode 20 is b, the width of the portions of the upper surface of the single connecting electrode 20 which are covered by the protective layer 40 is b-a, and the widths of the portions at two sides of the upper surface of the single connecting electrode 20 which are covered by the protective layer 40 are c and d, respectively, then b−a≦0.1b, c≦0.05b, and d≦0.05b. In this way, the contact area between the connecting electrode 20 and the connecting line 31 of the flexible printed circuit board is maintained uncovered to the greatest extent while protecting the connecting electrode 20 from erosion. In the embodiment as shown in FIG. 4, the width a may be between the width of the connecting line 31 and the width of the single connecting electrode 20.

According to the embodiments of the invention, the touch panel may further comprise a touch function area. The touch function area comprises a plurality of touch sensing electrodes and touch driving electrodes. The touch sensing electrodes and the touch driving electrodes are electrically connected with the connecting electrodes of the circuit binding area. In one embodiment, the protective layer may further cover the touch driving electrodes and the touch sensing electrodes in the touch function area. The touch driving electrodes and the touch sensing electrodes are generally electrically conducive metals, thus they are easily oxidized or eroded upon contact with air. Covering the touch driving electrodes and the touch sensing electrodes with the protective layer can prevent them from oxidization or erosion which leads to failure of the touch function. Moreover, when the protective layer further covers the touch driving electrodes and the touch sensing electrodes, it is only required to set a corresponding light transmitting area and light shading area in areas of the mask corresponding to the touch function area and the connecting and binding area. The protective layer which covers the touch function area and the connecting and binding area simultaneously can be formed by means of a one time patterning process.

Certainly, it is also possible to form a protective layer individually in the touch function area for protecting the touch driving electrodes and the touch sensing electrodes. However, directly covering the touch driving electrodes and the touch sensing electrodes with the protective layer for the circuit binding area can further reduce the patterning process and simplify the manufacturing steps.

Since the connecting electrodes are arranged in the circuit binding area, whereas the circuit binding area corresponds to a non-display area of the display panel, in one embodiment, in order to prevent light leakage of the non-display area of the display panel, a film layer of black matrix may be formed beneath the connecting electrodes. The expressions “upper” and “lower” used in the respective embodiments of the present invention are based on the order of manufacturing the thin films or layer structures. For example, an upper thin film refers to a thin film that is formed subsequently, while a lower thin film refers to a thin film that is formed previously.

Another embodiment of the invention provides a display device comprising a touch panel as provided by any embodiment among the aforesaid embodiments of the invention. The display device may be display devices such as liquid crystal display, electronic paper and organic light-emitting diode (OLED) display as well as any product or component having display function such as television, digital camera, mobile phone and panel computer which comprises such display devices.

What have been stated above are only specific embodiments of the present invention. However, the protection scope of the present invention is not limited to this. Any variations or substitutions that can be easily conceived by one skilled in the art familiar with the present technical field shall be included in the protection scope of the present invention. Thus, the protection scope of the present invention shall be based on the protection scopes of the claims.

1-10. (canceled)

11. A touch panel comprising:
a circuit binding area, wherein the circuit binding area includes a plurality of connecting electrodes for binding and electrically connecting with a circuit board; and
a protective layer covering at least one side surface of a connecting electrode.

12. The touch panel according to claim 1, wherein the protective layer covers two side surfaces of a connecting electrode.

13. The touch panel according to claim 1, wherein the protective layer covers one side surface of each connecting electrode of the plurality of connecting electrodes.

14. The touch panel according to claim 1, wherein the protective layer covers two side surfaces of each connecting electrode of the plurality of connecting electrodes.

15. The touch panel according to claim 1, wherein the protective layer covers at least a portion of an upper surface of a connecting electrode, and the width of the covered portion of the upper surface of the connecting electrode is not greater than 30% of the width of the connecting electrode.

16. The touch panel according to claim 2, wherein the protective layer covers at least a portion of an upper surface of a connecting electrode, and the width of the covered portion of the upper surface of the connecting electrode is not greater than 30% of the width of the connecting electrode.

17. The touch panel according to claim 5, wherein covered portions of the upper surface of the connecting electrode are located at two sides of an uncovered portion of the upper surface not covered by the protective layer.

18. The touch panel according to claim 7, wherein the width of each covered portion is not greater than 5% of the width of the connecting electrode.

19. The touch panel according to claim 6, wherein covered portions of the upper surface of the connecting electrode are located at two sides of an uncovered portion of the upper surface not covered by the protective layer.

20. The touch panel according to claim 9, wherein the width of each covered portion is not greater than 5% of the width of the connecting electrode.

21. The touch panel according to claim 1, wherein the connecting electrode is a metal connecting electrode.

22. The touch panel according to claim 1, wherein a film layer of black matrix is formed beneath the connecting electrodes.

23. A touch panel comprising:
a circuit binding area, wherein the circuit binding area includes a plurality of connecting electrodes for binding and electrically connecting with a circuit board;
a protective layer covering at least one side surface of a connecting electrode; and
a touch function area comprising a plurality of touch sensing electrodes and touch driving electrodes, the touch sensing electrodes and the touch driving electrodes being electrically connected with the connecting electrodes of the circuit binding area;
wherein the protective layer covers the touch driving electrodes and the touch sensing electrodes of the touch function area.

24. A display device comprising:
a frame; and
a touch panel comprising:
a circuit binding area, wherein the circuit binding area includes a plurality of connecting electrodes for binding and electrically connecting with a circuit board; and
a protective layer covering at least one side surface of a connecting electrode.
